(19) United States
(12) Patent Application Publication
(10) Pub. No.: US 2001/0029532 A1
(43) Pub. Date: Oct. 11, 2001

(54) Gateway apparatus

(76) Inventors: Naonori Kato, Osaka (JP); Tomoaki Watahiki, Osaka (JP); Hideaki Takechi, Osaka (JP); Kouichi Matsumura, Osaka (JP); Masao Ikezaki, Osaka (JP)

Correspondence Address: Beveridge, DeGrandi, Weilacher & Young, L.L.P., Suite 800, 1850 M Street, N.W., Washington, DC, 20036, US

(21) Appl. No.: 09/818,644

(22) Filed: Mar. 28, 2001

(30) Foreign Application Priority Data
Mar. 31, 2000 (JP) 2000-097,136

(51) Int. Cl. G06F 15/173

(52) U.S. Cl. 709/223

(57) ABSTRACT

A gateway apparatus connected to a first network and a second network and for controlling the operation of an apparatus or a plurality of apparatuses of control objective connected to the first network depending on the instructions directed to the second network by an instructing apparatus connected to the first network for the apparatuses of control objective, the gateway apparatus has

monitoring means of monitoring the flow of the instructions for controlling the operation of the apparatuses of control objective, directed to the second network by the instructing apparatus; and

control signal outputting means of outputting a control signal for controlling the operation of the apparatuses of control objective to the apparatuses of control objective depending on the instructions when the flow of the instructions is monitored by the monitoring means.

### BACKGROUND OF THE INVENTION

1. Field of the Invention

The present invention relates to a gateway apparatus providing the function of controlling a plurality of electronic devices connected to a network.

2. Related Art of the Invention

Progress has been made recently in the realization of in-home networking technology for interconnecting electronic devices, for example, AV devices such as a TV, a VTR, a CD player, and an MD player, in a house thereby to operate them in linkage. Such technology includes: the bus standard of IEEE Std 1394-1995 set by IEEE (Institute of Electrical and Electronics Engineers); and AV/C Command Set standardized by 1394 Trade Association. These standards define the specification of a command set used for interconnecting various electronic devices into a network thereby to realize the mutual control.

On the other hand, with the spread of the Internet and PC's into homes, devised are both a method in which the Internet technology is used in operating the devices within a home and a method in which the convenience is improved using the information on the Internet. As an apparatus used for this purpose, a gateway apparatus having the communication function both for the Internet and for an in-home network has been proposed.

A known example of a prior art technology for controlling in-home electronic devices by using the information on the Internet is described in Japanese Laid-Open Patent Publication No. Hei 10-191463. The entire discloure of Japanese Laid-Open Patent Publication No. Hei 10-191463 are incorporated herein by reference in its entirety.

FIG. 3 shows the connection of an example of a prior art in-home network. This in-home network is a network including an electronic device which performs a predetermined action in response to a predetermined operation, and comprises: an electronic device having both the WWW server function of sending out HTML data including control codes for controlling the action and the interface function of communicating with external electronic devices connected to the network; and an electronic device for operating the above-mentioned another electronic device.

In order to consider the technology for controlling the electronic devices connected to an in-home network by using the information provided by means of WWW on the Internet, FIG. 2 shows an example of the case of a video reservation by using a TV program table (EPG data) provided on the Internet.

In FIG. 2, numeral 1301 indicates a gateway apparatus for interconnecting an in-home network and the Internet. Numeral 1302 indicates an HTTP server for providing EPG data. Numeral 1303 indicates EPG data described in HTML. Numeral 1304 indicates a video device of control objective. Numeral 1305 indicates a WWW browser capable of down-loading and displaying the HTML data 1303. Numeral 1306 indicates a storage area for the HTML data 1303 down-loaded by the WWW browser 1305. Numeral 1307 indicates a TV program recording reservation-dedicated application for sending out a control command to the video apparatus 1304 depending on the stored HTML data 1306. Numeral 1308 indicates a PC comprising the WWW browser 1305 and an EPG controller.

As shown in FIG. 2, the following two steps of procedure are necessary. 1) To access the HTTP server 1302 on the Internet using the WWW browser 1305 thereby to down-load the TV program table 1303 temporarily. And after down-loading it on the hard disk 1306 of the PC 1308, 2) to start the video reservation-dedicated application 1307 thereby to make reservation.

Since the WWW browser 1305 and the TV program recording reservation-dedicated application 1307 used at that time are different applications with each other, thereby causing inconvenience in operation for the user. Further, the necessity of the dedicated application 1307 causes a problem of limitation both in executable environment and in operable objective devices.

In order to resolve this problem, a scheme has been proposed in which an HTTP server and HTML data including control codes for controlling itself are provided and in which an electronic device is operated by providing the HTML data on request. FIG. 3 shows this scheme.

In FIG. 3, numeral 1401 indicates a gateway apparatus for interconnecting an in-home network and the Internet. Numeral 1402 indicates an HTTP server for providing EPG data. Numeral 1403 indicates EPG data described in HTML. Numeral 1404 indicates a video device of control objective. Numeral 1405 indicates a WWW browser capable of down-loading and displaying the HTML data 1403. Numeral 1406 indicates a storage area for the HTML data 1403 down-loaded by the WWW browser 1405. Numeral 1407 indicates a PC comprising the WWW browser 1405.

In this case, the video device 1404 is provided with the function of interpreting a user s recording instruction from the PC 1407 thereby to record the video depending on the interpretation. Accordingly, in this scheme, the browser can be used both for controlling an in-home electronic device such as the video device 1404 and for accessing the WWW on the Internet. That is, the user can operate the in-home electronic device such as the video device 1404 by the same method as that of accessing the Internet.

Further, an electronic device having WWW browser function can easily control an electronic device such as the video device 1404 having HTTP server function. Furthermore, the device can be used even in the case that an electronic device of the same kind or of a completely new kind is added in the home.

However, this scheme requires that an HTTP server is installed in each electronic device of control objective. That is, each electronic device needs to have the function of interpreting the instruction from the PC for controlling the electronic device. Further, since the HTML data for controlling each electronic device needs to be previously stored in the electronic device, it is difficult to add or change the function of the existing device, and it is also difficult to add or change an interface.

Further, there has been a problem that it is difficult to control the device from the outside of the home, and that controllable electronic devices are limited to those which include an HTTP server. Furthermore, since the information provided from a network, such as the Internet, includes a vast amount of various information, there has been a difficulty in selecting desired information among the vast amount of various information.

### SUMMARY OF THE INVENTION

The present invention provides means of resolving these problems simultaneously, that is, means of permitting the control of electronic devices, such as a TV, a VTR, and a CD player, connected to an in-home network by using an ordinary WWW browser alone and by using the information provided by the WWW on the Internet, wherein the control is achieved without installing an HTTP server in each electronic device of control objective, and wherein the devices can be controlled by the WWW browser directly without a user temporarily down-loading the information such as a program table and then starting a dedicated application. Further, the present invention provides the means not restricted by the control commands supported by the electronic devices to be controlled, wherein the control scheme can be freely set and easily enhanced at later stages.

Considering the problem that in case of controlling a plurality of electronic devices connected to a network, in a prior art gateway apparatus, the method of setting and controlling is difficult for users, an object of the present invention is to provide a gateway apparatus permitting users to easily control the plurality of electronic devices connected to the network.

The 1st invention of the present invention is a gateway apparatus connected to a first network and a second network and for controlling the operation of an apparatus or a plurality of apparatuses of control objective connected to said first network depending on the instructions directed to said second network by an instructing apparatus connected to said first network for said apparatuses of control objective, the gateway apparatus comprising:

monitoring means of monitoring the flow of the instructions for controlling the operation of said apparatuses of control objective, directed to said second network by said instructing apparatus; and

control signal outputting means of outputting a control signal for controlling the operation of said apparatuses of control objective to said apparatuses of control objective depending on the instructions when said flow of the instructions is monitored by said monitoring means.

In accordance with a first present invention, without installing an HTTP server in each electronic device of control objective (apparatus of control objective) connected to a first network, each electronic device (apparatuses of control objective) connected to the first network can be controlled through an operation screen on which the string of data which has been down-loaded by a WWW browser of an instructing apparatus such as a PDA apparatus connected to the first network and is provided from an HTTP server connected to a second network.

The 2nd invention of the present invention is a gateway apparatus according to 1st invention, further comprising control information setting means in which control information for controlling the operation of said apparatuses of control objective is set, wherein

said control signal outputting means outputs said control signal by using said control information set in said control information setting means.

The 3rd invention of the present invention is a gateway apparatus according to 2nd invention, wherein said control information is set in said control information setting means by an access from said instructing apparatus, by a user's input operation, or by an access from said apparatuses of control objective.

The 4th invention of the present invention is a gateway apparatus according to 1st invention, further comprising identification information storing means of storing the identification information of each of said apparatuses of control objective, wherein

said control signal outputting means outputs said control signal by using said identification information stored in said identification information storing means.

The 5th invention of the present invention is a gateway apparatus according to 4th invention, wherein said identification information is stored in said identification information storing means by an access from said instructing apparatus, by a user's input operation, or by an access from said apparatuses of control objective.

The 6th invention of the present invention is a gateway apparatus according to 4th invention, further comprising device identification information acquiring means of acquiring said identification information of each of said apparatuses of control objective from all or a part of said apparatuses of control objective, wherein

said identification information storing means stores said identification information obtained by said device identification information acquiring means.

In a sixth present invention, device identification information acquiring means can automatically acquire the identification information of each electronic device (apparatus of control objective) connected to a first network. Accordingly, even when the number of electronic devices connected to the first network changes dynamically or when the addresses thereof are changed, each electronic device connected to the first network can be controlled without a user resetting the electronic device identification information.

The 7th invention of the present invention is a gateway apparatus according to any one of 1st to 6th invention, further comprising data converting means of converting the data from said second network into data available for said instructing apparatus.

In a seventh present invention, the WWW browser of an instructing apparatus such as a PDA apparatus connected to a first network can be provided with means of selecting an electronic device of control objective connected to the first network. Accordingly, even when a plurality of electronic devices (apparatuses of control objective) are connected to the first network, each electronic device can be controlled.

The 8th invention of the present invention is a program for causing a computer to serve as all or a part of:

said monitoring means of monitoring the flow of the instructions for controlling the operation of said apparatuses of control objective, directed to said second network by said instructing apparatus; and

said control signal outputting means of outputting a control signal for controlling the operation of said apparatuses of control objective to said apparatuses of control objective depending on the instructions when said flow of the instructions is monitored by said monitoring means; each in a gateway apparatus of 1st invention.

### BRIEF DESCRIPTION OF THE DRAWINGS

FIG. 1 is a configuration diagram of a gateway apparatus of a third embodiment of the present invention.

FIG. 2 is a configuration diagram of a network of the prior art.

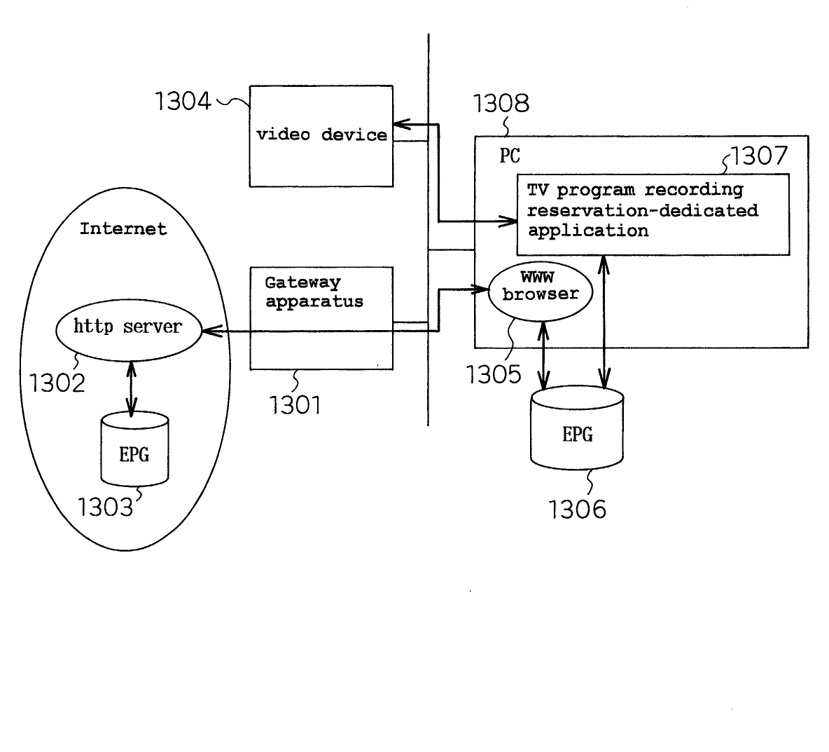

FIG. 3 is a configuration diagram of a network of the prior art.

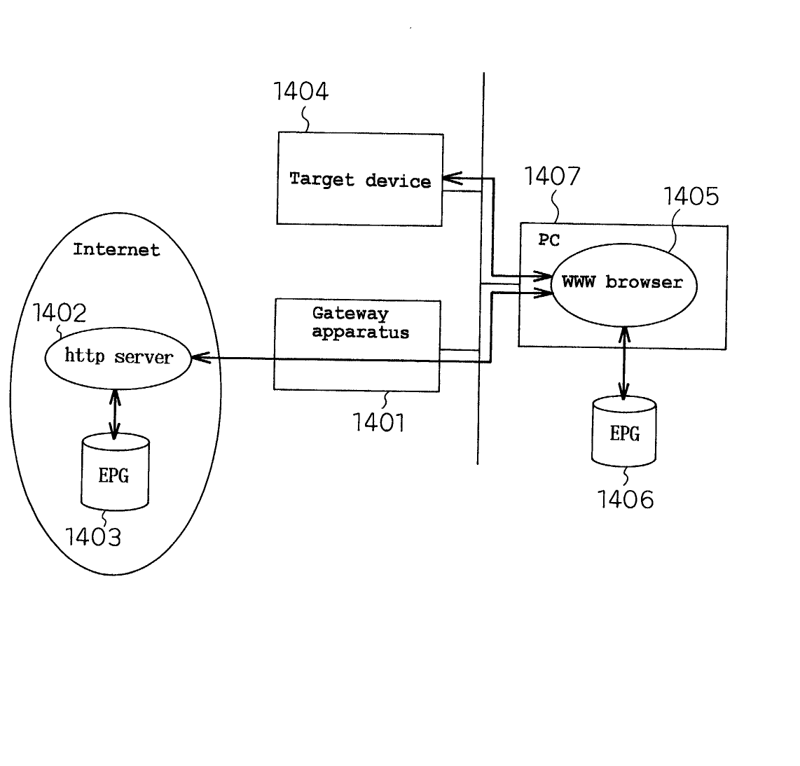

FIG. 4 is a diagram of a configuration using a gateway apparatus of a first embodiment of the present invention.

FIG. 5 is a configuration diagram of a gateway apparatus of a first embodiment of the present invention.

FIG. 6 is a diagram used for the description of an electronic device identification information table of a first embodiment of the present invention.

FIG. 7 is a diagram showing an example of the display of HTML data provided by an HTTP server in accordance with a first and a second embodiment of the present invention.

FIG. 8 is a diagram of a configuration using a gateway apparatus of a second embodiment of the present invention.

FIG. 9 is a configuration diagram of a gateway apparatus of a second embodiment of the present invention.

FIG. 10 is a diagram used for the description of an electronic device identification information table of a second embodiment of the present invention.

FIG. 11 is a diagram showing an example of the display of HTML data provided to an WWW server in accordance with a second embodiment of the present invention.

FIG. 12 is a diagram showing an example of the display of HTML data provided to an WWW server in accordance with a second embodiment of the present invention.

FIG. 13 is a diagram of a configuration using a gateway apparatus of a third embodiment of the present invention.

FIG. 14 is a diagram used for the description of an electronic device identification information table of a third embodiment of the present invention.

FIG. 15 is a diagram showing an example of the display of HTML data provided to an HTTP server in accordance with a third embodiment of the present invention.

FIG. 16 is a diagram showing an example of the display of HTML data provided to an WWW server in accordance with a third embodiment of the present invention.

FIG. 17 is a diagram showing an example of the display of HTML data provided to an WWW server in accordance with a third embodiment of the present invention.

FIG. 18 is a diagram used for the description of an electronic device identification information table of a first embodiment of the present invention.

[Description of the Reference Numerals]

101 Gateway apparatus

102 WWW browser

103 PDA apparatus

104 Video apparatus

105 EPG data described in HTML

106 HTTP server

201 Communication controlling means to Internet

202 Communication controlling means to in-home network

203 Data monitoring means

204 Data replacing means

205 Electronic device identification information table

206 Electronic device identification information acquiring means

207 Control command issuing means

209 Electronic device identification information inputting means

302 Name of class of electronic device

303 Address of electronic device

304 Character string indicating device of recording objective

401 TV program selection button

402 Reservation button

403 Radio button for selecting electronic device of recording objective

404 Radio button for selecting electronic device of recording objective

405 Replaced HTML data

502 WWW browser

503 PDA apparatus

504 Video apparatus

505 EPG data described in HTML

506 HTTP server

507 Video apparatus

602 Name of class of electronic device

603 Address of electronic device

701 TV program selection button

702 Reservation button

703 Radio button for selecting electronic device of recording objective

704 Label indicating name of electronic device of recording objective

705 Radio button for selecting electronic device of recording objective

706 Label indicating name of electronic device of recording objective

707 Replaced HTML data

802 WWW browser

803 PDA apparatus

804 Oven range apparatus

805 Cooking data described in HTML

806 HTTP server

807 Oven range apparatus

1101 Menu selection button

1102 Cooking start button

1103 Radio button for selecting electronic device of recording objective

1104 Radio button for selecting electronic device of recording objective

1105 EPG data described in HTML

1201 Menu selection button

1202 Cooking start button

1203 Radio button for selecting electronic device of cooking objective

1204 Label indicating name of electronic device of cooking objective

1205 Radio button for selecting electronic device of cooking objective

1206 Label indicating name of electronic device of cooking objective

1207 EPG data described in HTML

1301 Gateway apparatus

1302 HTTP server providing EPG data

1303 EPG data described in HTML

1304 video device of control objective

1305 WWW browser

1306 Storage area for HTML data 1303

1307 TV program recording reservation-dedicated application

1308 PC

1401 Gateway apparatus

1402 HTTP server providing EPG data

1403 EPG data described in HTML

1404 video device of control objective

1405 WWW browser

1406 Storage area for HTML data 1403

1407 PC

### DETAILED DESCRIPTION OF THE INVENTION

(First Embodiment)

A first embodiment of the present invention is described below with reference to the drawings.

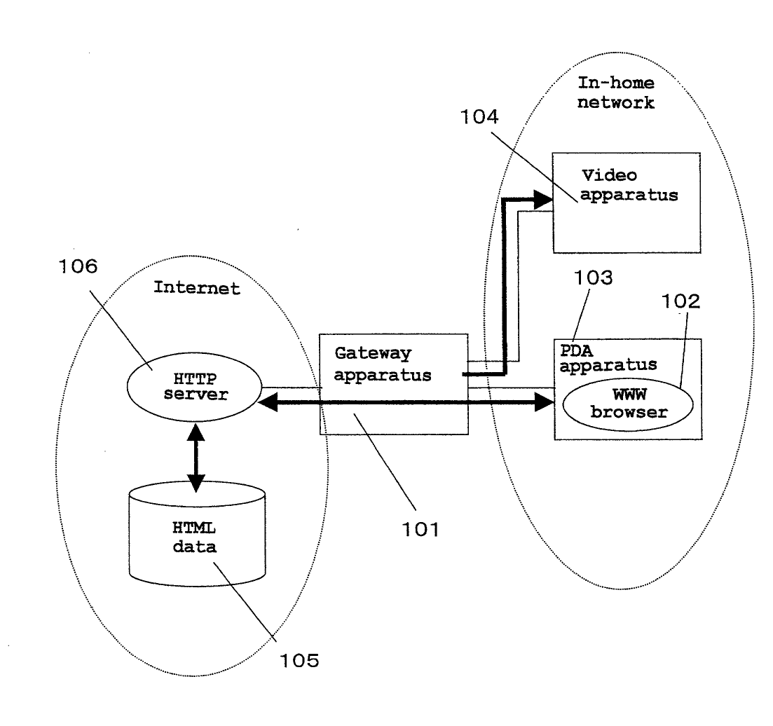

FIG. 4 is a diagram of a configuration using a gateway apparatus of the first embodiment of the present invention. The description of the first embodiment is made for an exemplary configuration in which a first network is an in-home network, a second network is the Internet, and a gateway apparatus 101 of the first embodiment interconnects the Internet and the in-home network.

In FIG. 4, numeral 101 indicates a gateway apparatus of the first embodiment of the present invention. Numeral 102 indicates a WWW browser for permitting the browsing of HTML data. Numeral 103 indicates a PDA (personal digital assistant) apparatus comprising the WWW browser 102. Numeral 104 indicates a video apparatus which is an electronic device of control objective. Numeral 105 indicates HTML data which is described in HTML and includes EPG data and a control screen for controlling the video apparatus 104. Numeral 106 indicates an HTTP server for providing the HTML data 105. The PDA apparatus 103 and the video apparatus 104 are connected to the gateway apparatus 101, and the gateway apparatus 101 is in turn connected to the Internet.

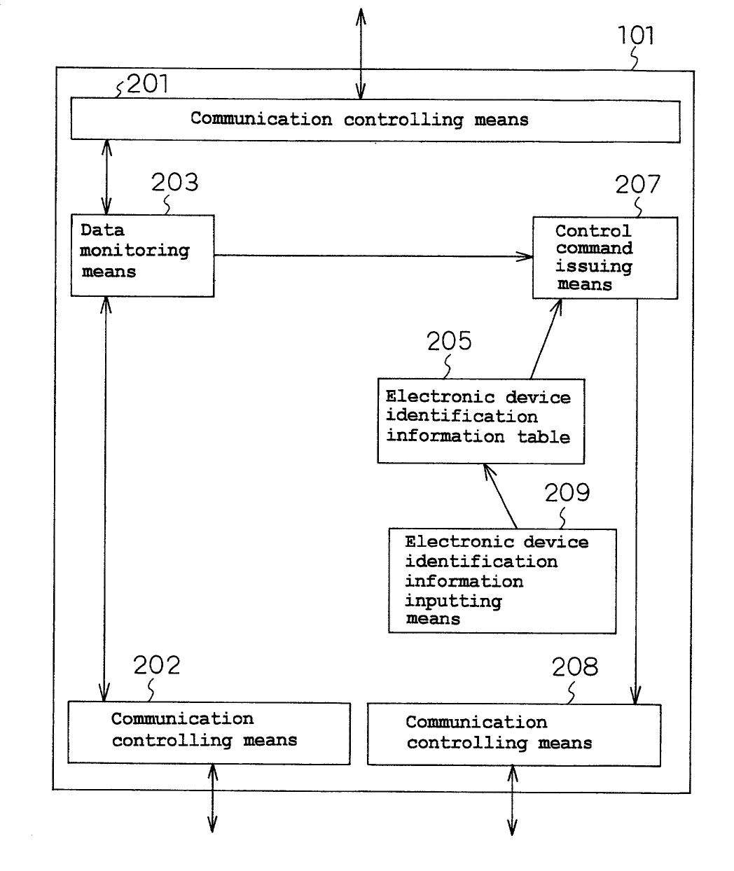

FIG. 5 is a configuration diagram of the gateway apparatus of the first embodiment of the present invention. In FIG. 5, numeral 201 indicates communication controlling means to the Internet. Numeral 202 indicates communication controlling means to the PDA apparatus 103 connected to the in-home network. Numeral 208 indicates communication controlling means to the video apparatus 104 connected to the in-home network. Numeral 203 indicates data monitoring means of monitoring the data string which flows from the communication controlling means 201 to the communication controlling means 202. Numeral 205 indicates an electronic device identification information table for storing both the identification information of an electronic device connected through the communication controlling means 208 and the information for controlling the electronic device. Numeral 209 indicates means of registering a user input to the electronic device identification information table 205. Numeral 207 indicates control command issuing means of issuing a control command to an electronic device connected to the communication controlling means 208.

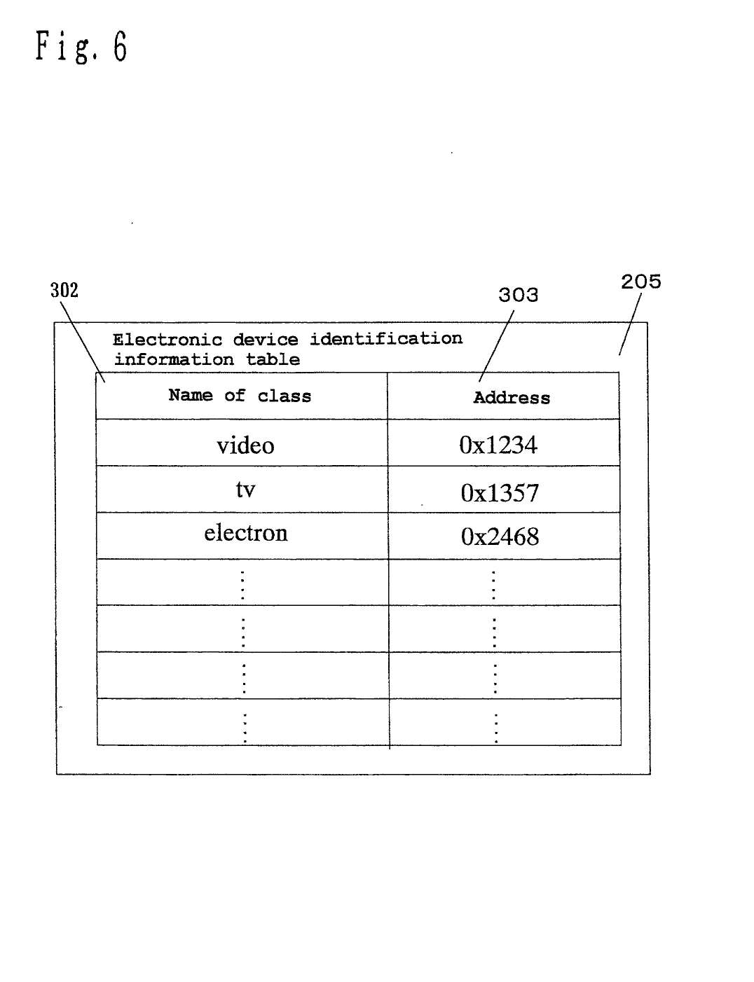

FIG. 6 illustrates the electronic device identification information which is input from the electronic device identification information inputting means 209 and then stored in the electronic device identification information table 205 in this embodiment. In FIG. 6, numeral 302 indicates the name of class of each electronic device connected to the communication controlling means 208. Numeral 303 indicates the address of each electronic device registered in the name 302 of class of electronic device. The registered name 302 of class of an electronic device is a name of category such as a TV, a video player, and a CD player. The address 303 is sufficient to uniquely specify an electronic device connected to the communication controlling means 208.

The first embodiment having the above-mentioned configuration is described below for an example of the case of making a recording reservation in the video apparatus 104 connected to the in-home network both by using TV program information which is described in HTML and provided by the HTTP server 106 connected to the Internet and by using an operation on the display screen of the WWW browser 102 having down-loaded a reservation screen (HTML data 105). This gives the description of the operation of the gateway apparatus 101 of the first embodiment of the present invention.

First, a user requests HTML data 105 to the HTTP server 106 for providing the HTML data 105 by using the WWW browser 102.

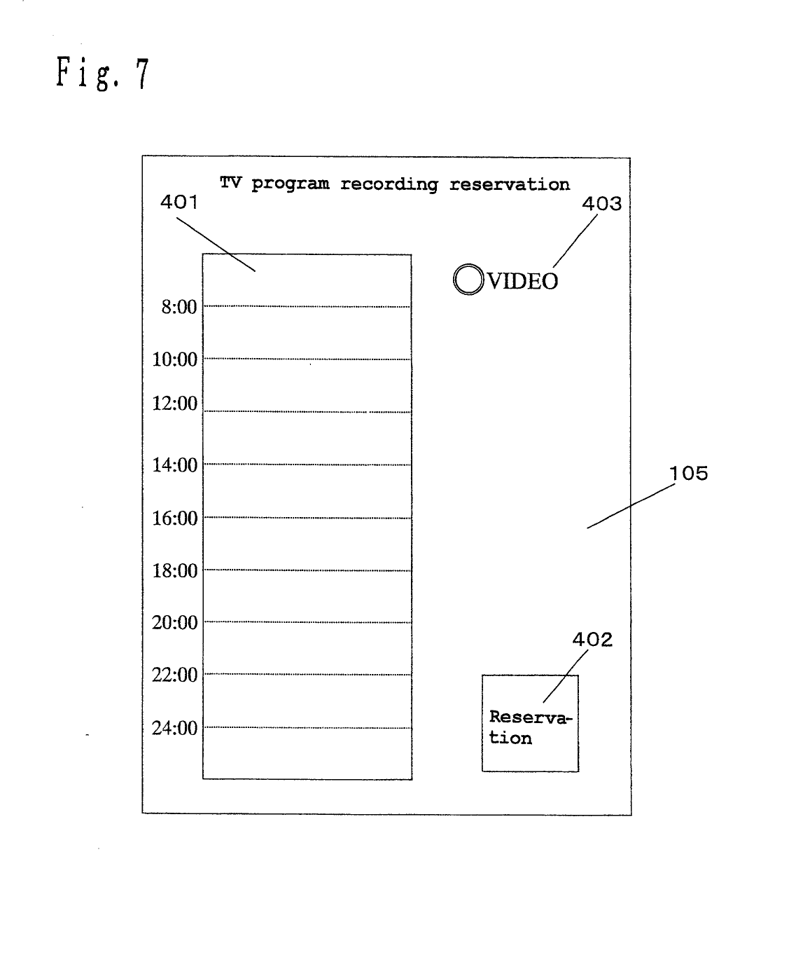

FIG. 7 shows an example of the display of the HTML data 105 provided by the HTTP server 106. In FIG. 7, numeral 401 indicates a TV program selection button. Numeral 402 indicates a reservation button. Numeral 403 indicates a radio button for selecting an electronic device of recording objective.

Next, the HTTP server 106 having received the request of HTML data 105 sends out the HTML data 105 to the WWW browser 102 via the gateway apparatus 101 of the first embodiment of the present invention. The WWW browser 102 then displays the down-loaded HTML data 105 onto the screen.

Next, a user selects a TV program which he desires to record and push the determination button 402. At this time, the WWW browser 102 adds, to the PUT instruction of HTTP, the information (TV program recording reservation information), such as the channel selected by the user, the recording start time, the recording stop time, and the device of recording objective, which is necessary to record the TV program, thereby sending it out to the HTTP server 106 via the gateway apparatus 101 of the first embodiment of the present invention.

The operation of the gateway apparatus 101 of the first embodiment of the present invention is described below in detail with reference to FIG. 5. In the gateway apparatus 101 of the first embodiment of the present invention, the data monitoring means 203 monitors the data string which flows from the communication controlling means 202 for the in-home network to the communication controlling means 201 for the Internet. When detecting a PUT instruction of HTTP in the data string, the data monitoring means 203 sends out the TV program recording reservation information attached to the PUT instruction, to the control command issuing means 207.

The control command issuing means 207 having received the TV program recording reservation information from the data monitoring means 203 first acquires the address information of the electronic device of destination of the control command from the TV program recording reservation information. When the acquired information is a name of class, an address is specified by referring the electronic device identification information table 205 for the address.

The control command issuing means 207 then acquires a device-proper control code from the control command-control code correspondence table registered in the electronic device identification information table 205 by using both the address information and the control command of the device of control objective, thereby issuing the control command such as an AV/C command to the communication controlling means 208 depending on the received TV program recording reservation information. The communication controlling means 208 then outputs the control command from the control command issuing means 207 to the video apparatus 104.

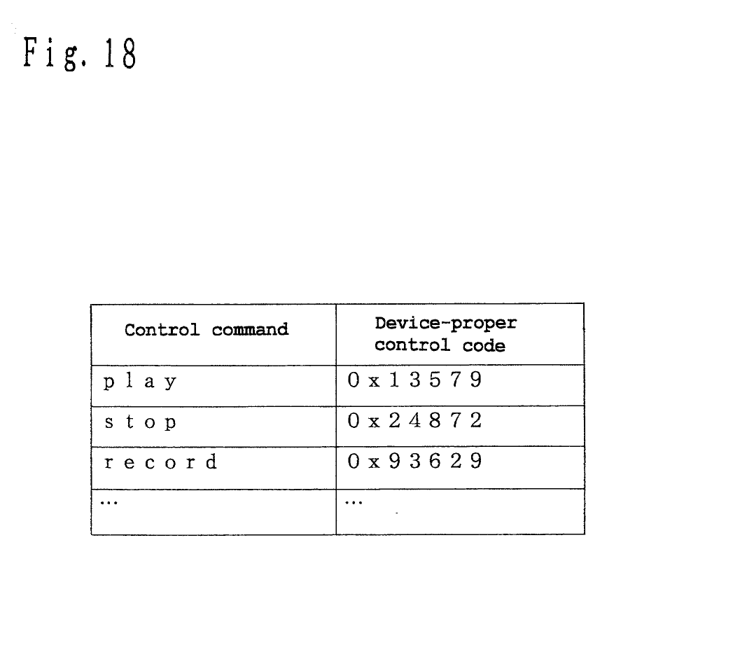

The control command output from the control command issuing means 207 is a command using the control information stored in the table 205 shown in FIG. 18. FIG. 18 is a diagram used for describing the control command-control code correspondence table indicating the correspondence relation between the control command and the device-proper control code. It should be noted that the control command-control code correspondence table is prepared for each command system of the devices of control objective, and input from the electronic device identification information inputting means 209.

The present embodiment has been described for a method of monitoring the HTML request by using the HTTP server as the server. However, the present invention is not restricted to this combination. That is, it is sufficient that a specific data pattern is monitored in the data string and that the replacement is carried out as described above. Accordingly, the kind of network and protocol is not a problem, and hence for example, XML may be used in place of HTML.

Further, the present embodiment has been described for an example of the case that the first network is an in-home network and that the second network is the Internet. However, the present invention is not restricted to this combination. That is, it is sufficient that the networks can be interconnected by a gateway apparatus of the present invention. Accordingly, the configuration of connection is not restricted to any specific configuration, and hence for example, the first network may be identical to the second network.

Further, the above-mentioned first embodiment has been described for an example of the case that the information for controlling the video apparatus 104 is stored in the electronic device identification information table 205. However, it is also possible that the information for controlling the video apparatus 104 is included in the data transmitted by the PDA apparatus 103 through the gateway apparatus 101 to the Internet and that the control command issuing means 207 issues the control command by using the information within the data.

Furthermore, the above-mentioned first embodiment has been described for an example of the case that the information registered in the electronic device identification information table 205 is input from the electronic device identification information inputting means 209. However, the information may be registered in the electronic device identification information table 205 by directly inputting to the gateway apparatus 101 by the user, by accessing from the PDA apparatus 103, or by accessing from the video apparatus 104.

(Second Embodiment)

A second embodiment of the present invention is described below with reference to the drawings.

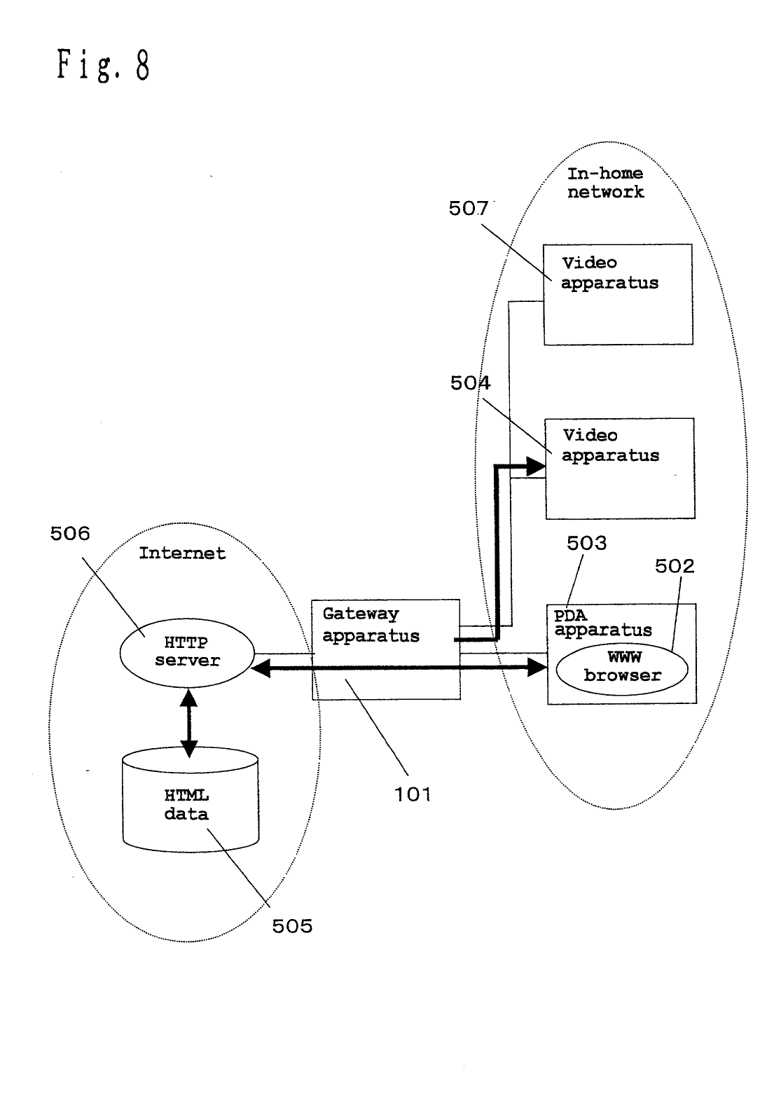

FIG. 8 is a diagram of a configuration using a gateway apparatus of the second embodiment of the present invention. The description of the second embodiment is made for an exemplary configuration in which a first network is an in-home network, a second network is the Internet, and a gateway apparatus 101 of the second embodiment interconnects the Internet and the in-home network.

In FIG. 8, numeral 101 indicates a gateway apparatus of the second embodiment of the present invention. Numeral 502 indicates a WWW browser for permitting the browsing of HTML data. Numeral 503 indicates a PDA apparatus comprising the WWW browser 502. Numeral 504 indicates a video apparatus which is an electronic device of control objective. Numeral 505 indicates HTML data which is described in HTML and includes EPG data and a control screen for controlling the video apparatus 504. Numeral 506 indicates an HTTP server for providing the HTML data 505. Numeral 507 is a video apparatus having the same function as that of the video apparatus 504.

The PDA apparatus 503, the video apparatus 504, and the video apparatus 507 are connected to the gateway apparatus 101, and the gateway apparatus 101 is in turn connected to the Internet.

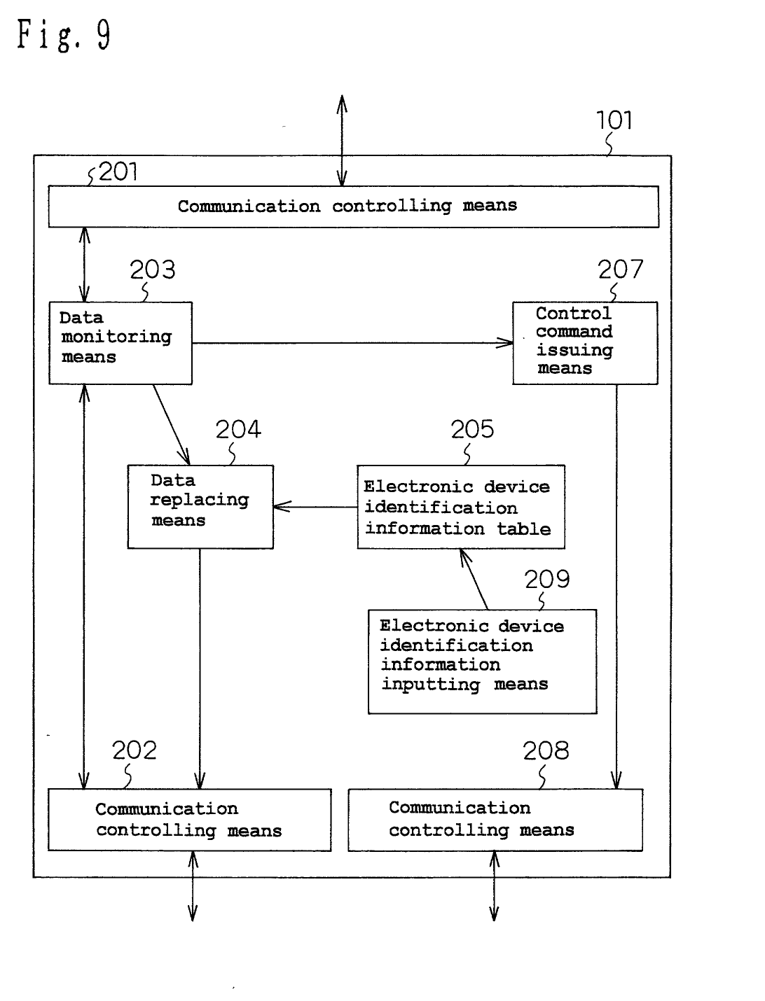

FIG. 9 is a configuration diagram of the gateway apparatus of the second embodiment of the present invention. In FIG. 9, numeral 201 indicates communication controlling means to the Internet. Numeral 202 indicates communication controlling means to the PDA apparatus 503 connected to the in-home network. Numeral 208 indicates communication controlling means to the video apparatuses 504, 507 connected to the in-home network. Numeral 203 indicates data monitoring means of monitoring the data string which flows from the communication controlling means 201 to the communication controlling means 202. Numeral 205 indicates an electronic device identification information table for storing both the identification information of each electronic device connected through the communication controlling means 208 and the information for controlling the electronic device. Numeral 209 indicates means of registering a user input to the electronic device identification information table 205. Numeral 204 indicates data replacing means of replacing a data string received from the data monitoring means 203 depending on the address information obtained from the electronic device identification information table 205. Numeral 207 indicates control command issuing means of issuing a control command to an electronic device connected to the communication controlling means 208.

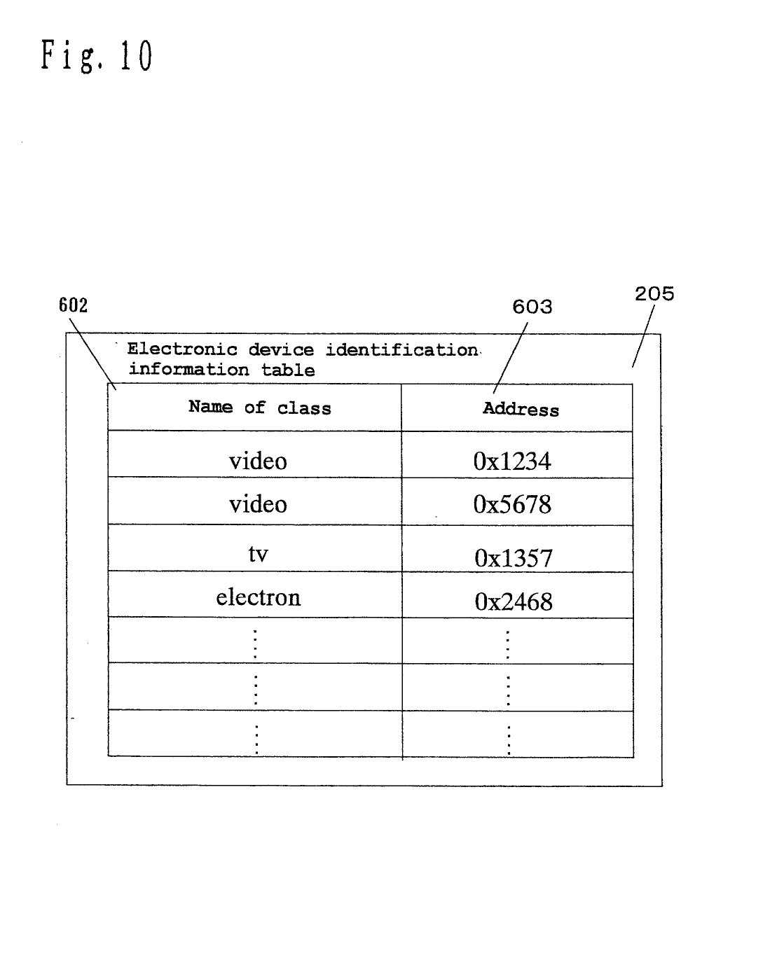

FIG. 10 illustrates the electronic device identification information which is input from the electronic device identification information inputting means 209 and then stored in the electronic device identification information table 205 in this embodiment. In FIG. 10, numeral 602 indicates the name of class of each electronic device connected to the communication controlling means 208. Numeral 603 indicates the address of each electronic device registered in the name 602 of class of electronic device. The registered name 602 of class of an electronic device is a name of category such as a TV, a video player, and a CD player. The address 603 is sufficient to uniquely specify an electronic device connected to the communication controlling means 208. In the configuration of FIG. 8, two video apparatuses are connected, and hence the names of class and the addresses of the two video apparatuses are registered in the electronic device identification information table 205.

The second embodiment having the above-mentioned configuration is described below for an example of the case of making a recording reservation in the video apparatus 504 or 507 connected to the in-home network both by using TV program information which is described in HTML and provided by the HTTP server 506 connected to the Internet and by using an operation on the display screen of the WWW browser 502 having down-loaded a reservation screen (HTML data 505). This gives the description of the operation of the gateway apparatus 101 of the second embodiment of the present invention.

First, a user requests HTML data 505 to the HTTP server 506 for providing the HTML data 505 by using the WWW browser 502.

FIG. 7 shows an example of the display of the HTML data 505 provided by the HTTP server 506. In FIG. 7, numeral 401 indicates a TV program selection button. Numeral 402 indicates a reservation button. Numerals 403, 404 indicate radio buttons for selecting an electronic device of recording objective.

Next, the HTTP server 506 having received the request of HTML data 505 sends out the HTML data 505 to the WWW browser 502 via the gateway apparatus 101 of the second embodiment of the present invention. The WWW browser 502 then displays the down-loaded HTML data 505 onto the screen.

The operation when the HTML data 505 sent out from the HTTP server 506 passes through the gateway apparatus 101 of the second embodiment of the present invention is described below in detail with reference to FIG. 9. In the gateway apparatus 101 of the second embodiment of the present invention, the data monitoring means 203 monitors the data string which flows from the communication controlling means 201 for the Internet to the communication controlling means 202 for the in-home network. When detecting a specific character string in the data string, the data monitoring means 203 sends out the detected character string to the data replacing means 204.

The data replacing means 204 then replaces the received data string depending on the referred electronic device identification information table 205 thereby to send it out to the communication controlling means 202. For example, the case in which the gateway apparatus 101 receives the HTML data 505 shown in FIG. 7 is considered below. Here, it is assumed that a previously defined character string not displayed on the WWW browser is described in the radio button 403 of the HTML data 505. At that time, the data monitoring means 203 detects the defined character string described in the HTML data 505 thereby to send out the HTML data 505 to the data replacing means 204.

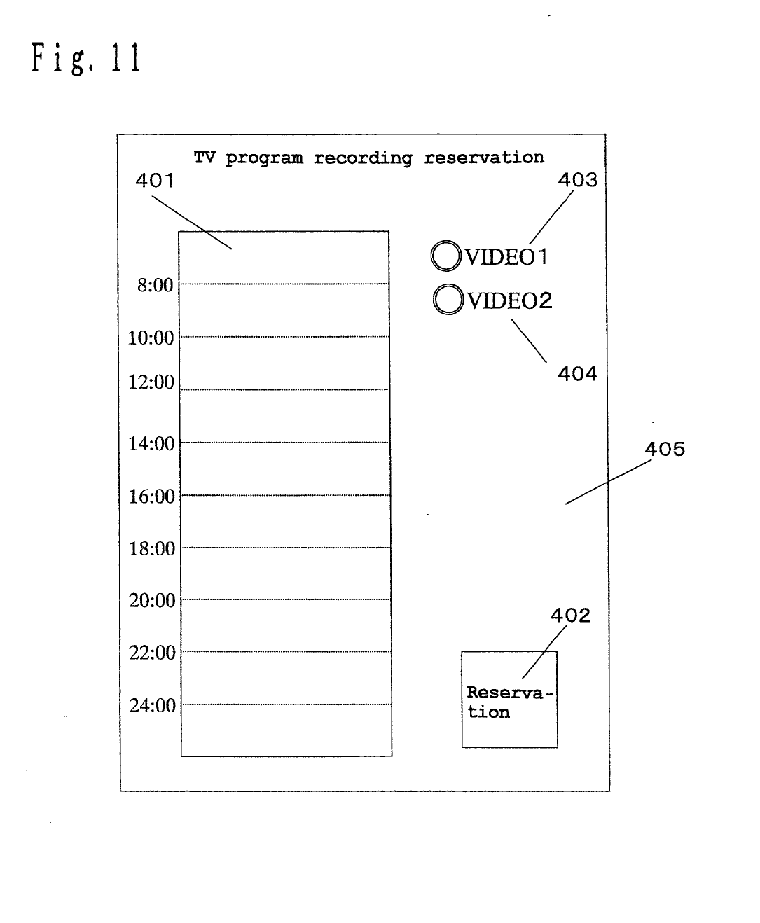

The data replacing means 204 having received the HTML data 505 refers the electronic device identification information table 205 thereby to perform the address resolution of the name of class of the electronic device of control objective described in the HTML data 505, and then replace the contents of the HTML data 505 depending on the information. In this example, since two video apparatuses are registered in the electronic device identification information table 205, another radio button is added so as to permit the selection of the video apparatus of recording objective. FIG. 11 shows an example of the HTML data sent out to the WWW browser 502 after the replacement.

When the electronic device identification information table 205 contains further detailed electronic device identification information such as the maker, the icon image, and the name of the device, the data replacing means 204 can use such information in the replacement. For example, in case of an input HTML data shown in FIG. 7, the gateway apparatus 101 can perform the replacement using the icon image illustrating the video apparatus and the name of the video apparatus in place of the radio button for video apparatus selection.

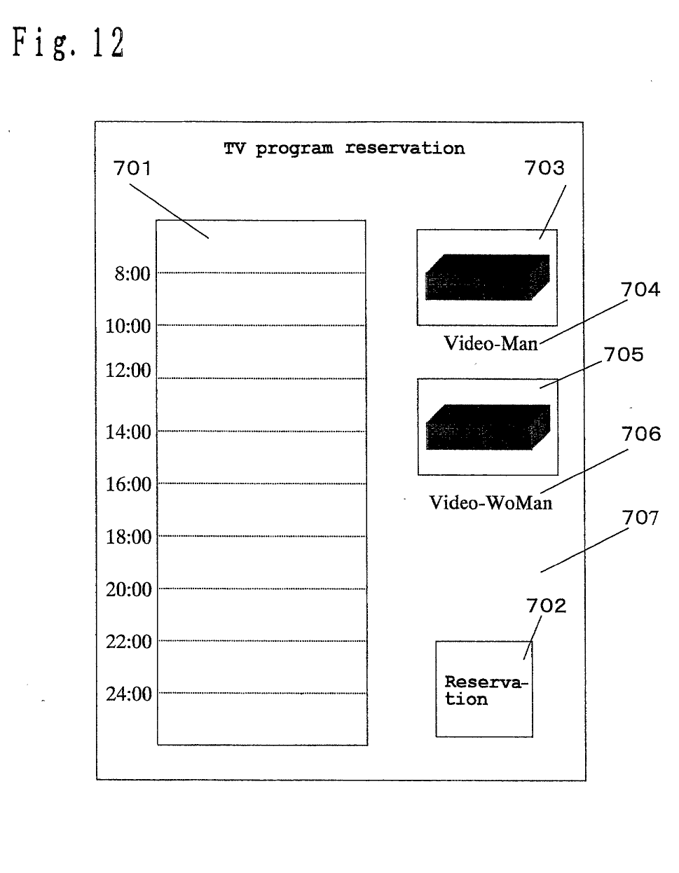

FIG. 12 shows an example of the display of the HTML data provided to the WWW browser. In FIG. 12, numeral 701 indicates a TV program selection button. Numeral 702 indicates a reservation button. Numeral 703 indicates an icon image indicating a first video apparatus, while numeral 704 indicates the name of the first video apparatus. Numeral 705 indicates an icon image indicating a second video apparatus, while numeral 706 indicates the name of the second video apparatus. The icon images 703, 705 can be selected by using an inputting apparatus such as a mouse instead of the radio button. The following description is made by using the HTML data 707 shown in FIG. 12.

Next, a user selects a TV program which he desires to record, and selects an video apparatus of recording objective by pushing an icon 703 or 705 and by pushing the determination button 702. At this time, the WWW browser adds, to the PUT instruction of HTTP, the information (TV program recording reservation information) , such as the channel selected by the user, the recording start time, the recording stop time, and the device of recording objective, which is necessary to record the TV program, thereby sending it out to the HTTP server 506 via the gateway apparatus 101 of the second embodiment of the present invention.

The operation of the gateway apparatus 101 of the second embodiment of the present invention is described below in detail. In the gateway apparatus 101 of the second embodiment of the present invention, the data monitoring means 203 monitors the data string which flows from the communication controlling means 202 for the in-home network to the communication controlling means 201 for the Internet. When detecting a PUT instruction of HTTP, the data monitoring means 203 sends out the TV program recording reservation information attached to the PUT instruction, to the control command issuing means 207.

The control command issuing means 207 having received the TV program recording reservation information from the data monitoring means 203 first acquires the address information of the electronic device of destination of the control command from the TV program recording reservation information. Since the acquired address information is already address-resolved, the control command issuing means 207 issues the control command such as an AV/C command to the communication controlling means 208 depending on the intact received TV program recording reservation information. Here, the issuing of the control command is carried out in the same manner as that described in the first embodiment.

The present embodiment has been described for a method of monitoring the HTML request by using the HTTP server as the server. However, the present invention is not restricted to this combination. That is, it is sufficient that a specific data pattern is monitored in the data string and that the replacement is carried out as described above. Accordingly, the kind of network and protocol is not a problem, and hence for example, XML may be used in place of HTML.

Further, the present embodiment has been described for an example of the case that the first network is an in-home network and that the second network is the Internet. However, the present invention is not restricted to this combination. That is, it is sufficient that the networks can be interconnected by a gateway apparatus of the present invention. Accordingly, the configuration of connection is not restricted to any specific configuration, and hence for example, the first network may be identical to the second network. Further, for example, in case that both of the first and the second networks of the present embodiment are the Internet, the same effect as described in the above-mentioned embodiment is obviously obtained also when an in-home network device is controlled through the public line and the Internet by using a portable PDA apparatus.

(Third Embodiment)

A third embodiment of the present invention is described below with reference to the drawings.

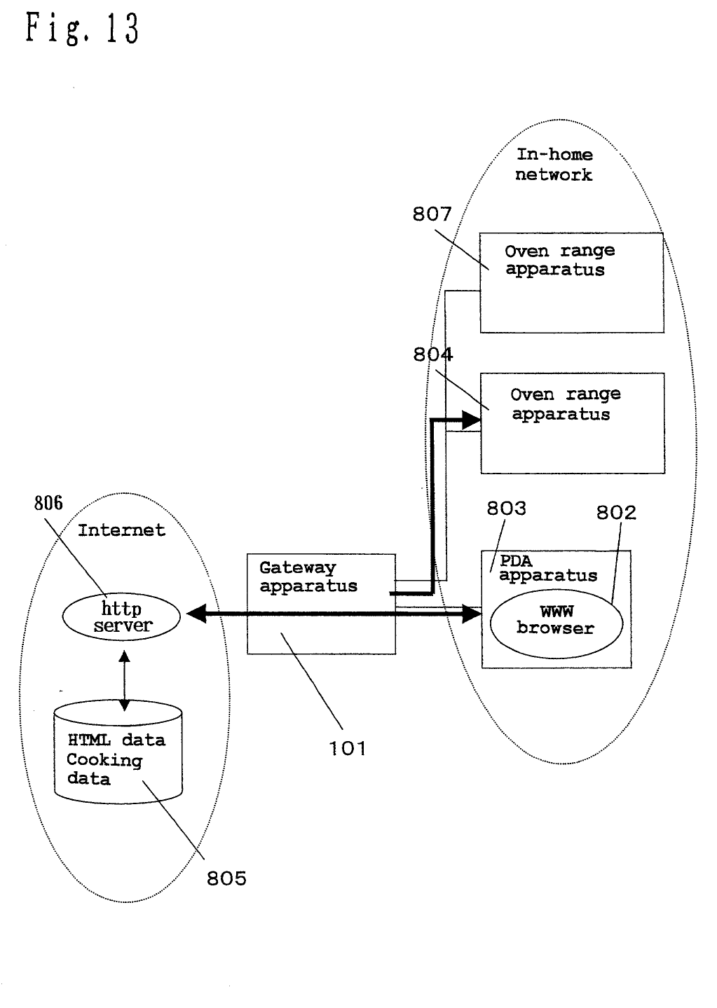

FIG. 13 is a diagram of a configuration using a gateway apparatus of the third embodiment of the present invention. The description of the third embodiment is made for an exemplary configuration in which a first network is an in-home network, a second network is the Internet, and a gateway apparatus 101 of the third embodiment interconnects the Internet and the in-home network.

In FIG. 13, numeral 101 indicates a gateway apparatus of the third embodiment of the present invention. Numeral 802 indicates a WWW browser for permitting the browsing of HTML data. Numeral 803 indicates a PDA apparatus comprising the WWW browser 802. Numeral 804 indicates an oven range apparatus which is an electronic device of control objective. Numeral 805 indicates HTML data which is described in HTML and includes cooking data and a control screen for controlling the oven range apparatus 804. Numeral 806 indicates an HTTP server for providing the HTML data 805. Numeral 807 is an oven range apparatus having the same function as that of the oven range apparatus 804.

The PDA apparatus 803, the oven range apparatus 804, and the oven range apparatus 807 are connected to the gateway apparatus 101, and the gateway apparatus 101 is in turn connected to the Internet.

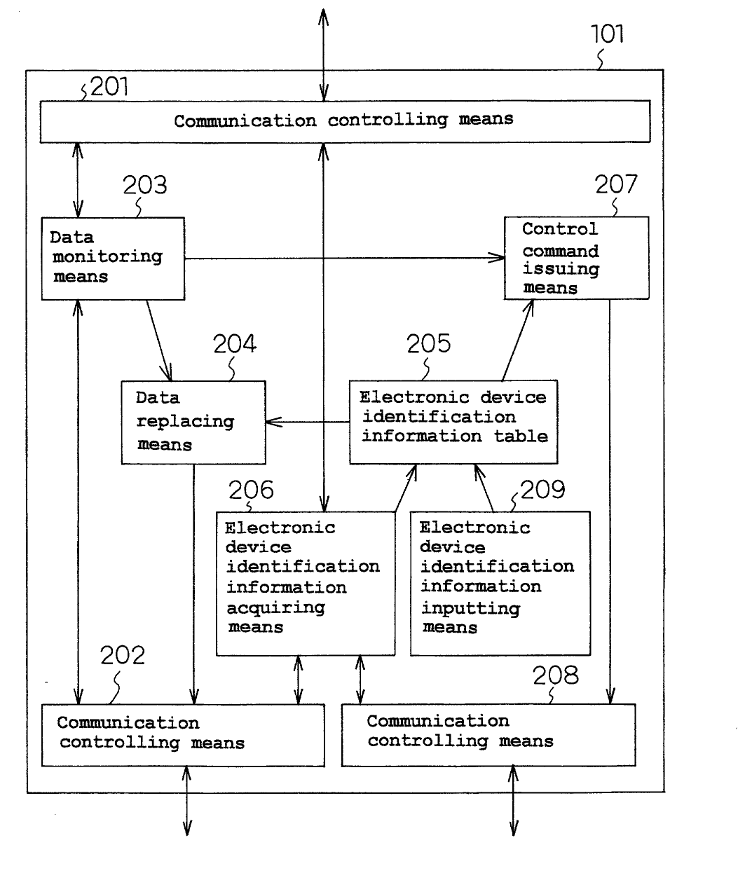

FIG. 1 is a configuration diagram of the gateway apparatus of the third embodiment of the present invention. In FIG. 1, numeral 201 indicates communication controlling means to the Internet. Numeral 202 indicates communication controlling means to the PDA apparatus 803 connected to the in-home network. Numeral 208 indicates communication controlling means to the oven range apparatus 804 and the oven range apparatus 807 connected to the in-home network. Numeral 203 indicates data monitoring means of monitoring the data string which flows from the communication controlling means 201 to the communication controlling means 202. Numeral 205 indicates an electronic device identification information table for storing the identification information of each electronic device connected through the communication controlling means 208. Numeral 206 indicates means of acquiring the electronic device identification information from the communication controlling means 201, the communication controlling means 202 or communication controlling means 208 thereby to register it to the electronic device identification information table 205. Numeral 209 indicates means of registering a user input to the electronic device identification information table 205. Numeral 204 indicates data replacing means of replacing a data string received from the data monitoring means 203 depending on the address information obtained from the electronic device identification information table 205. Numeral 207 indicates control command issuing means of issuing a control command to an electronic device connected to the communication controlling means 208.

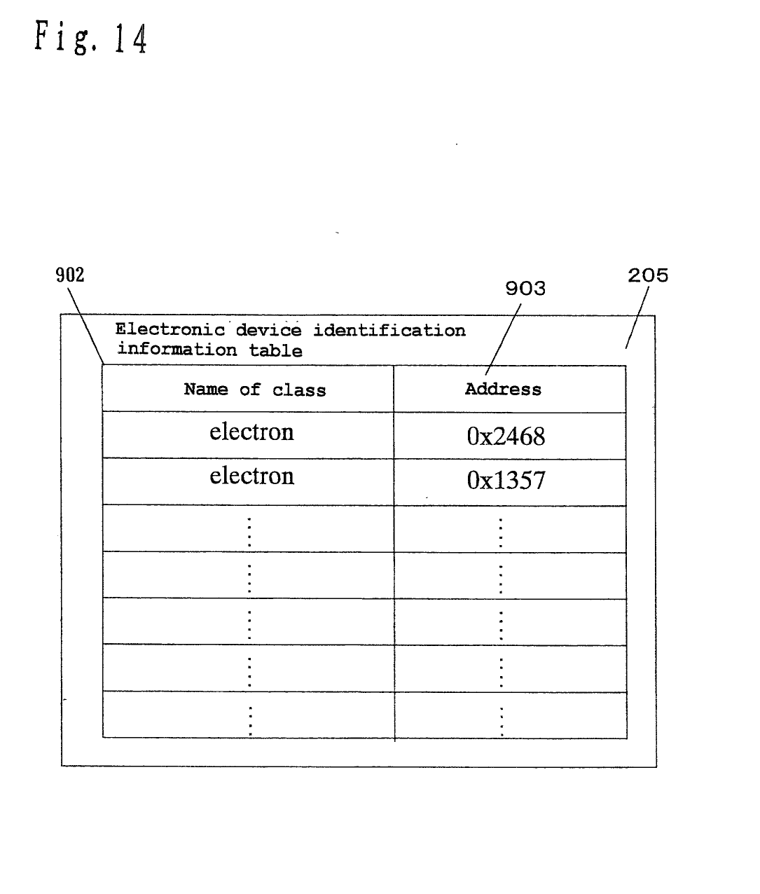

FIG. 14 illustrates the electronic device identification information table 205 containing the result of the electronic device identification information of each electronic device connected to the communication controlling means 208 automatically obtained by the electronic device identification information acquiring means 206. The electronic device identification information acquiring means 206 can treat also the electronic device identification information sent both from the Internet via the communication controlling means 201 and from the PDA apparatus 802 connected to the in-home network via the communication controlling means 202.

For example, when the network connected via the communication controlling means 208 is an IEEE 1394 network, the electronic device identification information acquiring means 206 monitors the state of the network connected to the communication controlling means 208, via the communication controlling means 208.

In case of the occurrence of a change in the state of the network, for example, when a new device is added to the network connected to the communication controlling means 208, the electronic device identification information acquiring means 206 detects the change in the state thereby to inquire the electronic device identification information, such as the device name, the device address, the icon, and the control command, to every device connected to the network.

On receiving the reply from each device, the electronic device identification information acquiring means 206 registers the acquired electronic device identification information into the electronic device identification information table. As such, the electronic device identification information shown in FIG. 14 is registered in the electronic device identification information table 205.

When a device connected to the network connected to the communication controlling means 208 comprises HAVi, the device can reply to the inquiry from the electronic device identification information acquiring means 206. That is, those devices which comprise HAVi can provide the electronic device identification information thereof.

In FIG. 14, numeral 902 indicates the name of class of each electronic device connected to the communication controlling means 208. Numeral 903 indicates the address of each electronic device registered in the name 902 of class of electronic device. The registered name 902 of class of an electronic device is a name of category such as a TV, a video player, and a CD player. The address 903 is sufficient to uniquely specify an electronic device connected to the communication controlling means 208.

In the configuration of FIG. 13, two oven range apparatuses are connected, and hence the names of class and the addresses of the oven range apparatuses are registered in the electronic device identification information table 205.

The third embodiment having the above-mentioned configuration is described below for an example of the case of cooking with an oven range apparatus connected to the in-home network both by using cooking information which is described in HTML and provided by the HTTP server connected to the Internet and by using an operation on the display screen of the WWW browser 802 having down-loaded a cooking selection screen (HTML data 805). This gives the description of the operation of the gateway apparatus 101 of the third embodiment of the present invention.

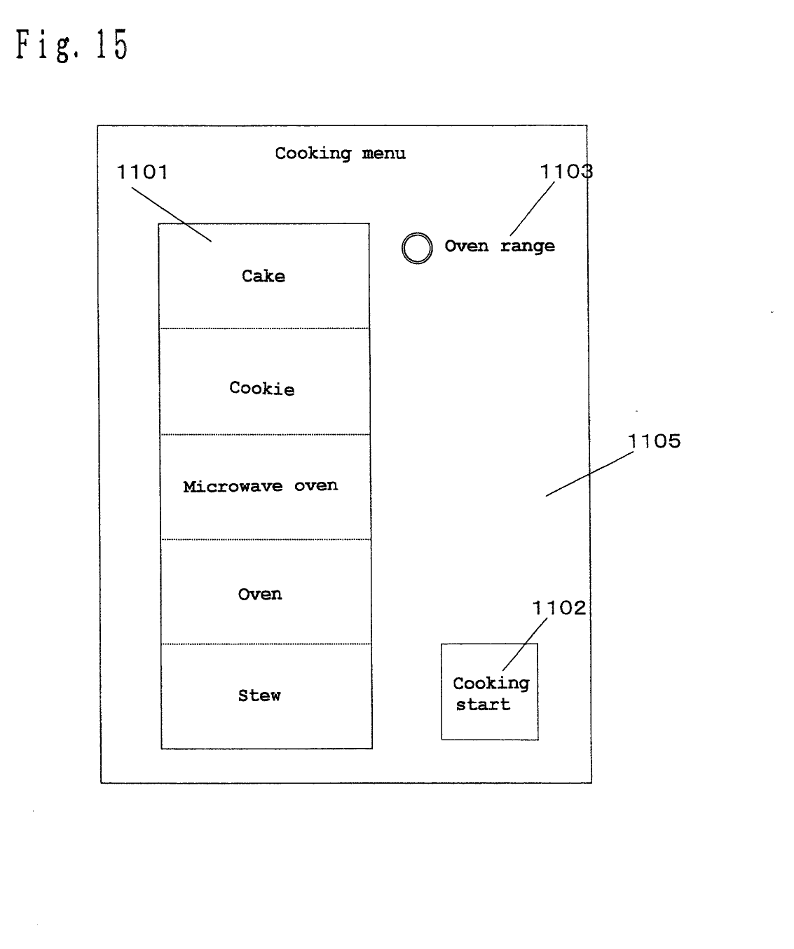

First, a user requests HTML data 805 to the HTTP server 806 for providing both the cooking information and the cooking selection screen (HTML data 805) described in HTML by using the WWW browser 802. FIG. 15 shows an example of the display of the HTML data 805 provided by the HTTP server 806. In the figure, numeral 1101 indicates a menu selection button. Numeral 1102 indicates a cooking start button. Numeral 1103 indicates a radio button for selecting an electronic device of cooking objective.

Next, the HTTP server 806 having received the request of HTML data 805 sends out the HTML data 805 to the WWW browser 802 via the gateway apparatus 101 of the third embodiment of the present invention.

The operation when the HTML data 805 sent out from the HTTP server 806 passes through the gateway apparatus 101 of the third embodiment of the present invention is described below in detail with reference to FIG. 1. In the gateway apparatus 101 of the present invention, the data monitoring means 203 monitors the data string which flows from the communication controlling means 201 for the Internet to the communication controlling means 202 for the in-home network. When detecting a specific character string in the data string, the data monitoring means 203 sends out the detected character string to the data replacing means 204.

The data replacing means 204 then refers the electronic device identification information table 205 thereby to replace the received data string depending on the result, thereby sending it out to the communication controlling means 202. For example, the case in which the gateway apparatus 101 receives the HTML data 1105 shown in FIG. 15 is considered below. Here, it is assumed that a previously defined character string not displayed on the WWW browser is described in the radio button 1103 of the HTML data 1105.

At that time, the data monitoring means 203 detects the defined character string described in the HTML data 1105 thereby to send out the HTML data 1105 to the data replacing means 204. The data replacing means 204 having received the HTML data 1105 refers the electronic device identification information table 205 thereby to perform the address resolution of the name of class of the electronic device of control objective described in the HTML data 1105, and then replace the contents of the HTML data 1105 depending on the information.

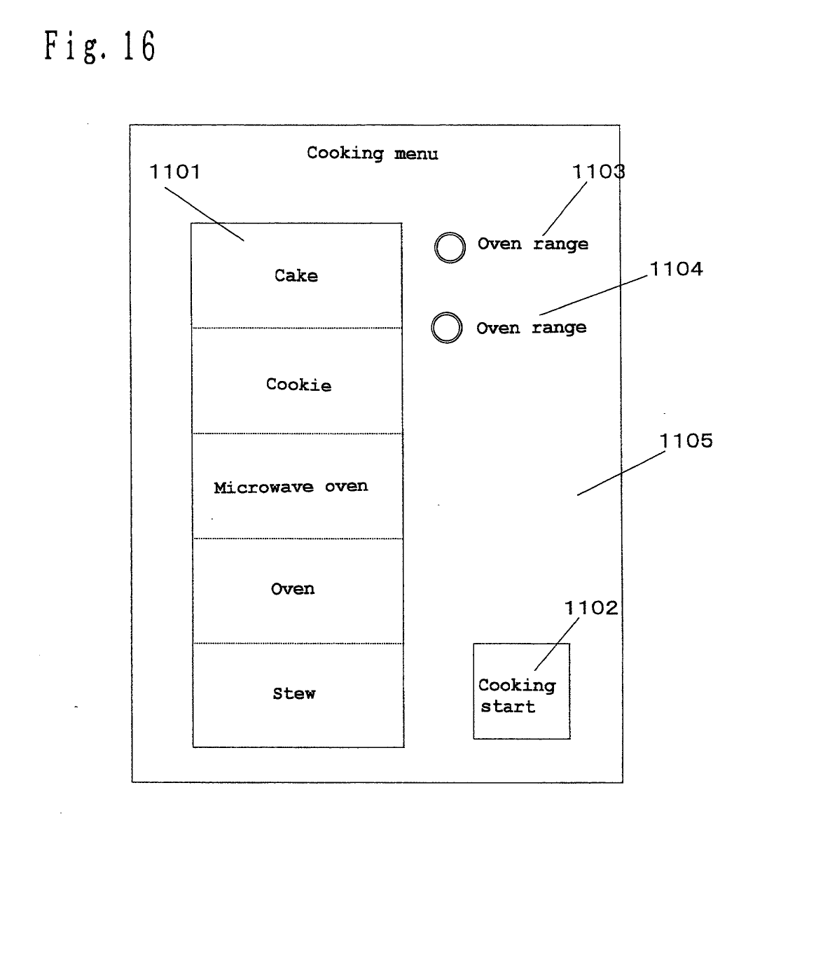

In this example, since two oven range apparatuses are registered in the electronic device identification information table 205, another radio button is added so as to permit the selection of the oven range apparatus of cooking objective. FIG. 16 shows an example of the HTML data after the replacement.

When the electronic device identification information table 205 contains further detailed electronic device identification information such as the maker, the icon image, and the name of the device, the data replacing means 204 can use such information in the replacement. For example, in case of an input HTML data shown in FIG. 15, the gateway apparatus 101 can perform the replacement using the icon image illustrating the oven range apparatus and the name of the oven range apparatus in place of the radio button for oven range apparatus selection.

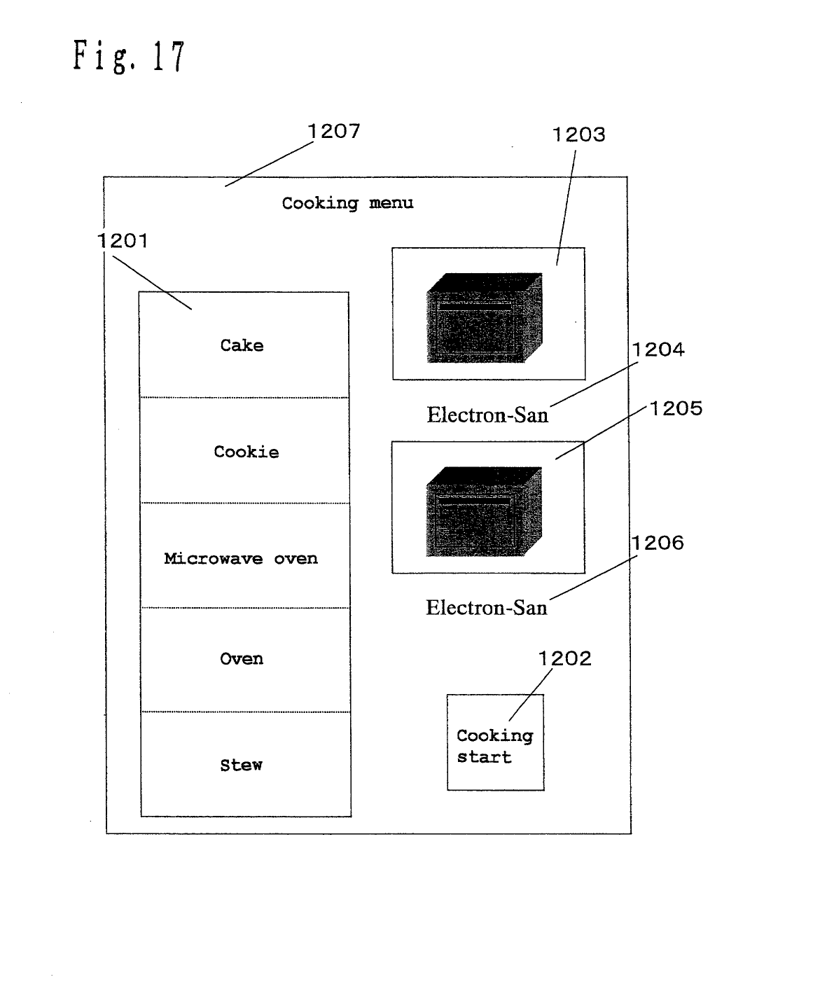

FIG. 17 shows an example of the display of the HTML data provided to the WWW browser. In the figure, numeral 1201 indicates a menu selection button. Numeral 1202 indicates a cooking start button. Numeral 1203 indicates an icon image indicating an oven range apparatus, while numeral 1204 indicates the name of the oven range apparatus. Numeral 1205 indicates an icon image indicating a second oven range apparatus, while numeral 1206 indicates the name of the second oven range apparatus. The icon images 1203, 1205 can be selected by using an inputting apparatus such as a mouse instead of the radio button. The following description is made by using the HTML data 1207 shown in FIG. 17.

Next, a user selects a menu which he desires to cook, and selects an oven range apparatus of cooking objective by pushing an icon 1203 or 1205 and by pushing the cooking start button 1202. At this time, the WWW browser 802 adds, to the PUT instruction of HTTP, the information (cooking information), such as cooking temperature, cooking time, cooking method, and the device of cooking objective, which is necessary to cook, thereby sending it out to the HTTP server 806 via the gateway apparatus 101 of the third embodiment of the present invention.

The operation of the gateway apparatus 101 of the third embodiment of the present invention is described below in detail. In the gateway apparatus 101 of the third embodiment of the present invention, the data monitoring means 203 monitors the data string which flows from the communication controlling means 202 for the in-home network to the communication controlling means 201 for the Internet. When detecting a PUT instruction of HTTP, the data monitoring means 203 sends out the cooking information attached to the PUT instruction, to the control command issuing means 207.

The control command issuing means 207 having received the cooking information from the data monitoring means 203 first acquires the address information of the electronic device of destination of the control command from the cooking information. Since the acquired address information is already address-resolved, the control command issuing means 207 issues the control command to the communication controlling means 208 depending on the intact received cooking information.

The present embodiment has been described for a method of monitoring the HTML request by using the HTTP server as the server. However, the present invention is not restricted to this combination. That is, it is sufficient that a specific data pattern is monitored in the data string and that the replacement is carried out as described above. Accordingly, the kind of network and protocol is not a problem, and hence for example, XML may be used in place of HTML.

Further, the present embodiment has been described for an example of the case that the first network is an in-home network and that the second network is the Internet. However, the present invention is not restricted to this combination. That is, it is sufficient that the networks can be interconnected by a gateway apparatus of the present invention. Accordingly, the configuration of connection is not restricted to any specific configuration, and hence for example, the first network may be identical to the second network.

Further, the present invention is a program for causing a computer to perform the function of all or a part of the means of the above-mentioned the gateway apparatus of the present invention, and hence a program working in cooperation with the computer.

Here, “a part of the means of the present invention” indicates either a certain number of pieces of the plural pieces of the means thereof or a part of the function of a piece of means.

Further, a computer readable recording medium having recorded a program of the present invention is included within the scope of the present invention.

In an embodiment of the use of a program of the present invention, the program may be recorded on a computer readable recording medium thereby to work in cooperation with a computer.

Further, in an embodiment of the use of a program of the present invention, the program may be transferred through a transferring medium, and read by a computer thereby to work in cooperation with the computer.

The media include a ROM, while the transferring media include a transferring medium such as the Internet, light, radio waves, and sound waves.

Further, the computer of the present invention referred above is not limited pure hardware such as CPU or the like, and it may include firmware, operating system, I/O devices and peripheral devices.

Further, as described above, the configuration of the present invention may be implemented by a software or a hardware.

As described above, the present invention permits the control of electronic devices, such as a TV, a VTR, and a CD player, in an in-home network by using information provided on the WWW of the Internet by using an ordinary WWW browser without preparing any dedicated application for the control.

At that time, each electronic device can be controlled without installing an HTTP server in each electronic device of control objective. Further, a user can instruct each electronic device directly without temporarily down-loading the information such as a program table.

Further, the present invention provides a notable effect that the system is not restricted by the control commands supported by the electronic devices to be controlled and that the control scheme can be freely set and easily enhanced at later stages.

What is claimed is:

1. A gateway apparatus connected to a first network and a second network and for controlling the operation of an apparatus or a plurality of apparatuses of control objective connected to said first network depending on the instructions directed to said second network by an instructing apparatus connected to said first network for said apparatuses of control objective, the gateway apparatus comprising:
monitoring means of monitoring the flow of the instructions for controlling the operation of said apparatuses of control objective, directed to said second network by said instructing apparatus; and
control signal outputting means of outputting a control signal for controlling the operation of said apparatuses of control objective to said apparatuses of control objective depending on the instructions when said flow of the instructions is monitored by said monitoring means.

2. A gateway apparatus according to claim 1, further comprising control information setting means in which control information for controlling the operation of said apparatuses of control objective is set, wherein
said control signal outputting means outputs said control signal by using said control information set in said control information setting means.

3. A gateway apparatus according to claim 2, wherein said control information is set in said control information setting means by an access from said instructing apparatus, by a user s input operation, or by an access from said apparatuses of control objective.

4. A gateway apparatus according to claim 1, further comprising identification information storing means of storing the identification information of each of said apparatuses of control objective, wherein
said control signal outputting means outputs said control signal by using said identification information stored in said identification information storing means.

5. A gateway apparatus according to claim 4, wherein said identification information is stored in said identification information storing means by an access from said instructing apparatus, by a user s input operation, or by an access from said apparatuses of control objective.

6. A gateway apparatus according to claim 4, further comprising device identification information acquiring means of acquiring said identification information of each of said apparatuses of control objective from all or a part of said apparatuses of control objective, wherein
said identification information storing means stores said identification information obtained by said device identification information acquiring means.

7. A gateway apparatus according to any one of claims 1 to 6, further comprising data converting means of converting the data from said second network into data available for said instructing apparatus.

8. A program for causing a computer to serve as all or a part of:
said monitoring means of monitoring the flow of the instructions for controlling the operation of said apparatuses of control objective, directed to said second network by said instructing apparatus; and
said control signal outputting means of outputting a control signal for controlling the operation of said apparatuses of control objective to said apparatuses of control objective depending on the instructions when said flow of the instructions is monitored by said monitoring means; each in a gateway apparatus of claim 1.
